(19) United States
(12) Patent Application Publication
(10) Pub. No.: US 2004/0141700 A1
(43) Pub. Date: Jul. 22, 2004

(54) Low power backlight module

(75) Inventor: Pang-Lun Yang, Taichung Hsien (TW)

Correspondence Address: Ladas & Parry, 26 West 61st Street, New York, NY, 10023, US

(73) Assignee: BENQ CORPORATION

(21) Appl. No.: 10/747,352

(22) Filed: Dec. 29, 2003

(30) Foreign Application Priority Data
Jan. 14, 2003 (TW) 92100717

(51) Int. Cl. G02B 6/08; F21V 7/04

(52) U.S. Cl. 385/120; 362/31; 385/901

(57) ABSTRACT

A backlight module includes a light guide plate, a lamp tube and a reflecting plate. The light guide plate has a lower surface, an upper surface and four lateral sides. The four lateral sides are substantially normal to the upper and the lower surfaces. The lamp tube is located on one lateral side of the light guide plate and projects lights into the light guide plate. The reflecting plate is located below the light guide plate to reflect the lights into the light guide plate. At least one surface of the upper surface, lower surface and lateral sides of the light guide plate is coated with a fluorescent agent to form a fluorescent layer which can adsorb and temporarily retain lights before emitting thereby increase the brightness, and uniformity of the backlight module and reduce power consumption of the lamp tube.

### FIELD OF THE INVENTION

The present invention relates to a backlight module for liquid crystal displays (LCDs) and particularly to a backlight module with a lower power consumption.

### BACKGROUND OF THE INVENTION

With rapid advance of manufacturing technologies in thin film transistor LCD (TFT-LCD), and the advantages of slim and light, power saving and low radiation, LCDs have been widely used in various types of electronic products such as personal digital assistant (PDA), notebook computers, digital cameras, video cameras, mobile phones, and the like. In addition, the industry has invested heavily in research and development and uses mass production facilities. As a result, quality of LCD continuously improves and the price drops relentlessly, application scope of LCD is expanded drastically. However LCD cannot generate light by itself. It requires a backlight module to accomplish a display function.

FIG. 1 is a cross-sectional view of a conventional backlight module 10. It includes a light guide plate 11, a reflecting plate 12, a lamp tube 13, a plurality of optical films 14 and an aluminum back cover 15. The light guide plate 11 is a transparent acrylic plate. The lower surface of the light guide plate has granular patterns of circular, hexagonal or square shapes formed by a screen-printing or injection method to serve as diffusion spots 16 to scatter light. The reflecting plate 12 is located below the light guide plate 11 to reflect the light projecting thereon into the light guide plate 11 to increase the utilization efficiency of the backlight module 10. The lamp tube 13 is located at one side of the light guide plate 11 and is usually a cold cathode tube to project light into the light guide plate 11 through one end thereof. The optical films 14 are located above the light guide plate 11. Composition and functions of the optical films 14 will be discussed later. The aluminum back cover 15 is located cover the lower surface and lateral sides of the backlight module 10 to protect the elements in the backlight module 10.

Referring to FIG. 2, the optical films 14 located above the upper surface of the light guide plate generally include a lower diffusing film 141, a prism film 142, a reflective polarization film 143 and an upper diffusing film 144. The upper and lower diffusing films 141 and 144 are used to diffuse light beams to obtain more uniform lights. The prism film 142 converges light to increase the brightness of the panel. The reflective polarization film 143 reflects the lights back into the light guide plate 11. It is to be note that FIG. 2 illustrates only one type of composition of the optical films 14. Other types of optical films 14 may be used in different types of displays. In any cases, the diffusing films 141 and 144 are the most important elements in the backlight module 10.

As previously discussed, the main function of the diffusing film is to diffuse incident lights to achieve a more uniform light output. It may be made from acrylic or plastics at a thickness between 0.1 and 0.2 mm. While the diffusing film can improve the uniformity of light, it also creates a masking effect and has negative impact to the brightness of backlight module. One piece of diffusing film can shield about 30% incident light. Namely, the brightness of light passing through a diffusing film is reduced to 70% of the original one. With two pieces of the diffusing film, more than one half of brightness will be shield. This has a great impact to the brightness of the LCD. In order to enable the LCD to obtain sufficient brightness without sacrificing the uniformity, the electric current of the lamp tube will be increased. Then, the power consumption of the backlight module must be increased, the inner temperature of the backlight module will be also increased, and thus affects the operation performance of the electronic elements located therein.

Therefore to overcome the disadvantages occurred to the conventional backlight modules and to improve the backlight module to consume lower power and achieve more uniform lighting without affecting the brightness thereby to save electricity, and achieve lower operation temperature and improved performance of electronic elements is a goal hotly pursued in the industry.

### SUMMARY OF THE INVENTION

The primary object of the invention is to provide a backlight module to reduce power consumption of the lamp tube without affecting the brightness and light uniformity of the backlight module.

Another object of the invention is to provide a low power backlight module to lower operation temperature of the backlight module without affecting the brightness and light uniformity to increase the operation performance of the electronic elements in the backlight module.

The low power backlight module according to the invention includes a light guide plate, a lamp tube and a reflecting plate. The light guide plate has a lower surface, an upper surface, and four lateral sides. The four lateral sides are substantially normal to the upper and the lower surfaces. The lamp tube is located atone lateral side of the light guide plate and projects light into the light guide plate. The reflecting plate is located below the light guide plate to reflect the light into the light guide plate to increase light utilization efficiency of the backlight module.

Among the upper surface, lower surface or lateral sides of the light guide plate, at least one of them is coated with a fluorescent agent to form a fluorescent layer. The fluorescent agent includes a plurality of diffusion granules and a transparent resin. The resin can adsorb the incident light and temporarily retain the lights before emission. The diffusion granules can scatter lights to achieve a more uniform light output. The fluorescent agent coated on the light guide plate has the same diffusion effect as the diffusing film to enable the backlight module to generate more uniform output lights. Compared with the diffusing film, the fluorescent agent used in the invention has a lower shielding ratio. Thus under the same power of the lamp tube, the backlight module of the invention can have a greater brightness. To reach the same requirement of brightness, the power consumption (electric current) of the lamp tube in the present invention becomes lower. Hence, the inner operation temperature also is lower. Thus the operation performance of the electronic elements in the backlight module may be improved.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a conventional backlight module.

FIG. 2 is a schematic view of a plurality of optical films formed on the upper surface of the light guide plate.

FIG. 3 is a sectional view of the backlight module in the present invention.

FIG. 4A is a schematic view of the fluorescent agent formed on the upper surface of the light guide plate.

FIG. 4B is a schematic view of the fluorescent agent formed on the upper surface and a lateral side of the light guide plate.

FIG. 5 is a schematic view of the fluorescent agent coating on the surface of the light guide plate.

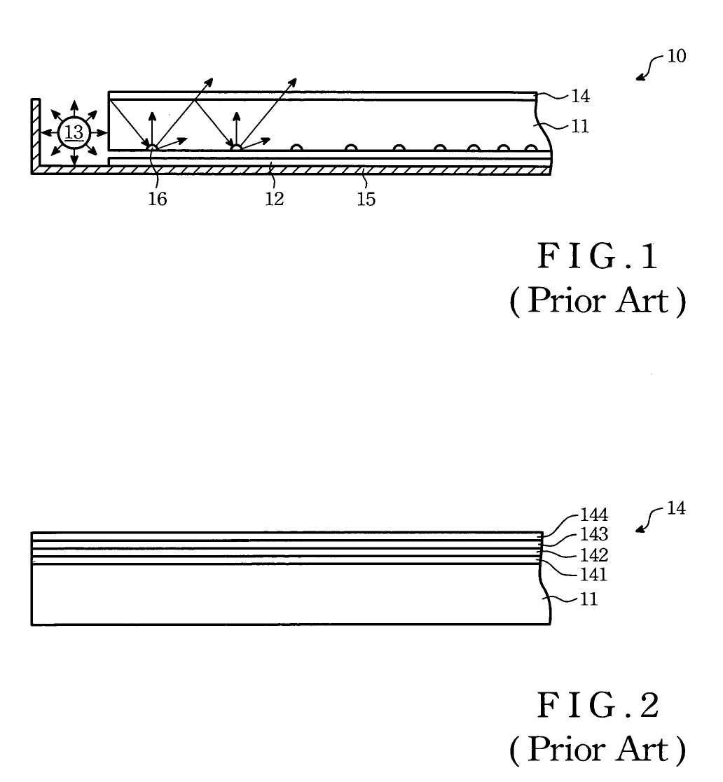

### DESCRIPTION OF THE PREFERRED EMBODIMENTS

The invention aims at providing a low power backlight module that has a light guide plate coated with a fluorescent agent to increase uniformity of the backlight module. The fluorescent agent provides a lower shielding ratio to increase the brightness of the backlight module and reduce electric current used in the lamp tube thereby to decrease power required for the backlight module. A preferred embodiment and its details are discussed as follows.

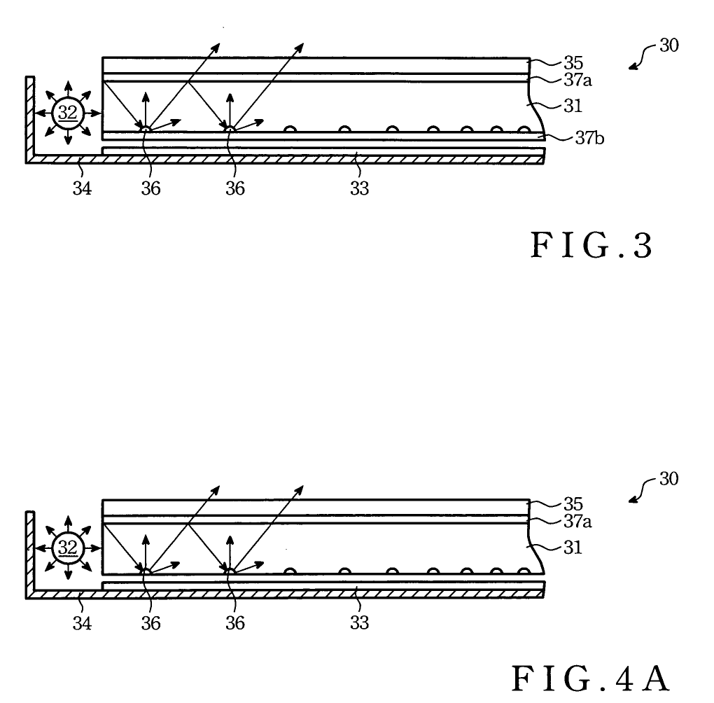

Referring to FIG. 3, the backlight module 30 of the invention includes a light guide plate 31, a lamp tube 32, a reflecting plate 33, an aluminum back cover 34 and a plurality of optical films 35. The light guide plate 31 has a lower surface, an upper surface and four lateral sides. The lateral sides are substantially normal to the upper surface and the lower surface. The light guide plate 31 is made of a transparent acrylic plate. The lower surface of the light guide plate is formed with granular patterns in circular, hexagonal or square shape by a screen-printing or injection method to form diffusion spots 36 to scatter light. The lamp tube 32 is located on one side of the light guide plate 31 and may be a cold cathode tube. The reflecting plate 33 is located below the light guide plate to reflect light into the light guide plate 31 to increase light source utilization of the backlight module 30. The optical films 35 are located above the light guide plate 31. Composition and functions of the optical films 35 have been explained in the background of the invention set forth above, thus details are omitted here. The aluminum back cover 34 is covered the lower and lateral sides of the backlight module 30 to protect the backlight module 30 and electronic elements located therein. In the present, at least one of the upper surface, lower surface or lateral sides of the light guide plate is coated with a fluorescent agent to form a fluorescent layer. Function of the fluorescent agent will be discussed later.

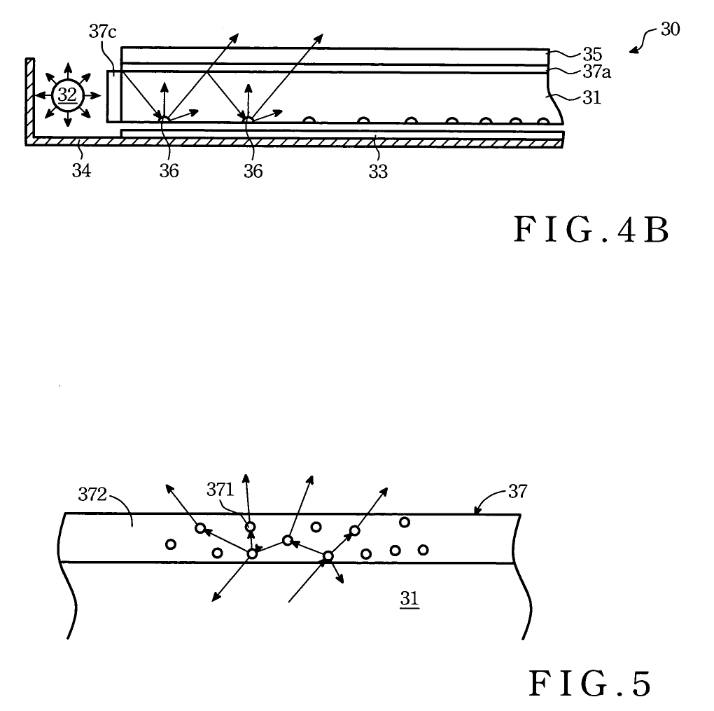

In one embodiment of the invention, fluorescent layers 37a and 37b are formed respectively on the upper surface and the lower surface of the light guide plate 31 as shown in FIG. 3. The fluorescent layer 37a may also be formed on a single surface, such as on the upper surface of the light guide plate 31 as shown in FIG. 4A. On the other hand, the fluorescent layers 37a and 37c may also be formed on the upper surface and a lateral side as shown in FIG. 4B.

Refer to FIG. 5 for the fluorescent agent coating on the light guide plate. The fluorescent layer 37 consists of a plurality of diffusion granules 371 and a transparent resin 372. The resin 372 may be triacetate cellulose (TAC). It can adsorb and temporarily retain incident light before emitting. The diffusion granules 371 can scatter incident light beams to generate more uniform output light. The fluorescent agent in the fluorescent layer 37 coated on the light guide plate 31 has the same effect as the diffusing film. Therefore the backlight module 30 can generate more uniform output lights. Moreover, the fluorescent agent used in the invention has a lower shielding ratio than conventional diffusing films. With the light source of the same power of lamp tube, the present invention can generate a greater brightness to boost light intensity. Namely, with the requirement of same brightness, the power consumption (electric current) of the lamp tube is lower. Thus the present invention can achieve a lower power consumption and a lower operation temperature. Thereby, the performance of the electronic elements in the backlight module can also increase.

In addition, the diffusing film can be eliminated because the fluorescent agent has the same effect of the diffusing film but with a lower shielding ratio. Cost of the optical films may be reduced from the backlight module. Moreover, in the conventional backlight module, the optical films shall be positioned in a predetermined location in the backlight module to prevent from skewing of these films. Some bright and dark lines might be formed on the display if any film is positioned in a wrong location. By contrast, the fluorescent layer used in the invention contains resin. After the upper surface of the light guide plate is coated with the fluorescent layer, the optical films may be positioned thereon to minimize skewing of the optical films. As a result, the quality of a LCD monitor may be improved.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A backlight module, comprising:
a light guide plate having a lower surface, an upper surface and lateral sides substantially normal to the upper surface and the lower surface,
a lamp tube located at one side of the light guide plate for projecting lights into the light guide plate;
a reflecting plate located below the light guide plate to reflect lights into the light guide plate; and
a fluorescent layer formed on at least one surface of the light guide plate, the fluorescent layer having a fluorescent agent, the fluorescent agent having a plurality of diffusion granules and a transparent resin, the resin adsorbing and temporarily retaining incident lights before emitting, and the diffusion granules scattering the incident light to generate more uniform output lights.

2. The backlight module of claim 1, wherein the fluorescent agent is coated on any one of the upper surface, the lower surface and the lateral sides.

3. The backlight module of claim 1, wherein the lamp tube is a cold cathode tube.

4. The backlight module of claim 1, wherein the light guide plate is a plate made from transparent acrylic that has a lower surface forming a plurality of diffusion spots to scatter light.

5. The backlight module of claim 1 further having a plurality of optical films located above the light guide plate.

6. A backlight module, comprising:
a light guide plate having a lower surface, an upper surface and lateral sides substantially normal to the upper surface and the lower surface;
a lamp tube located at one side of the light guide plate for projecting lights into the light guide plate;
a reflecting plate located below the light guide plate to reflect lights into the light guide plate; and
two fluorescent layers formed respectively on the upper surface and the lower surface of the light guide plate, each of the fluorescent layers containing a fluorescent agent, the fluorescent agent having a plurality of diffusion granules and a transparent resin, the resin adsorbing and temporarily retaining incident lights before emitting, the diffusion granules scattering the incident lights to generate more uniform output lights.

7. A backlight module, comprising:
a light guide plate having a lower surface, an upper surface and lateral sides substantially normal to the upper surface and the lower surface;
a lamp tube located at one side of the light guide plate for projecting lights into the light guide plate;
a reflecting plate located on the lower surface of the light guide plate to reflect lights into the light guide plate; and
two fluorescent layers formed respectively on the upper surface and one of the lateral sides of the light guide plate, each of the fluorescent layers containing a fluorescent agent, the fluorescent agent having a plurality of diffusion granules and a transparent resin, the resin adsorbing and temporarily retaining incident lights before emitting, and the diffusion granules scattering the incident light to generate more uniform output lights.
